(19) United States
(12) Patent Application Publication
(10) Pub. No.: US 2008/0013233 A1
(43) Pub. Date: Jan. 17, 2008

(54) Electrostatic breakdown protection circuit

(75) Inventors: Seiji Otake, Saitama (JP); Shuichi Kikuchi, Gunma (JP); Yasuo Oishibashi, Gunma (JP); Masao Seki, Gunma (JP); Tomoaki Nishi, Niigata (JP)

Correspondence Address: MORRISON & FOERSTER LLP, 1650 TYSONS BOULEVARD, SUITE 400, MCLEAN, VA, 22102, US

(73) Assignees: SANYO ELECTRIC CO., LTD., Moriguchi-Shi (JP); Sanyo Semiconductor Co., Ltd., Ora-Gun (JP)

(21) Appl. No.: 11/822,864

(22) Filed: Jul. 10, 2007

(30) Foreign Application Priority Data
Jul. 11, 2006 (JP) 2006-190686

(51) Int. Cl. H02H 9/00

(52) U.S. Cl. 361/56

(57) ABSTRACT

The invention is directed to providing an electrostatic breakdown protection circuit having an enhanced performance of protecting an internal circuit from a surge voltage such as static electricity (an operation speed or resistance to electrostatic breakdown). An N-channel type MOS transistor is connected between a wiring and a VSS (ground voltage) wiring. A first capacitor is connected between the wiring and a gate of the MOS transistor, and a second capacitor is connected between the VSS wiring and the gate. A voltage applied to an input/output terminal is divided by these capacitors, and the divided voltage is applied to the gate. When a surge voltage occurs, the MOS transistor is forced to turn on by the divided voltage to flow a current, thereby protecting an internal circuit. When a larger surge voltage occurs, a parasitic bipolar transistor turns on. A Zener diode is disposed between the gate and the VSS wiring in order to prevent a voltage applied to the gate from exceeding a predetermined voltage.

### CROSS-REFERENCE OF THE INVENTION

This invention claims priority from Japanese Patent Application No. 2006-190686, the content of which is incorporated herein by reference in its entirety.

### BACKGROUND OF THE INVENTION

1. Field of the Invention

The invention relates to an electrostatic breakdown protection circuit for preventing electrostatic breakdown of a semiconductor integrated circuit.

2. Description of the Related Art

A conventional semiconductor integrated circuit is provided with a protection circuit near an input/output terminal in order to enhance resistance to a surge voltage such as static electricity, an overvoltage or electromagnetic noise generated from peripheral devices (hereafter, referred to as an electrostatic breakdown protection circuit).

The conventional electrostatic breakdown protection circuit will be described referring to FIG. 5. An internal circuit 100 is provided on a semiconductor substrate made of a silicon wafer or the like. The internal circuit 100 is an analog circuit or a digital circuit, including an input circuit, an output circuit, an input/output circuit or the like. A MOS transistor type protection circuit 103 made of an N-channel type MOS transistor N is connected with a wiring 102 connecting the internal circuit 100 and the input/output terminal 101, where a source is connected with a ground wiring, a drain is connected with the wiring 102 and a gate and the source are in so-called diode-connection.

The operation of the MOS transistor type protection circuit 103 will be described. When a surge voltage 104 is applied through the input/output terminal 101, breakdown occurs between the source and the drain and thus a parasitic bipolar transistor of the MOS transistor N turns on and thereby a current flows from the input/output terminal 101 side to the ground voltage GND side.

This operation protects the internal circuit 100 from electrostatic breakdown. Various electrostatic breakdown protection circuits using a PN diode or a thyristor as an element of the electrostatic breakdown protection circuit are proposed as well as the one using the MOS transistor as described above.

The relevant technology is described in the Japanese Patent Application Publication No. Hei 5-102411, for example.

The recent finer and larger-scale integrated semiconductor devices tend to increase the electrostatic breakdown. However, the above-described conventional electrostatic breakdown protection circuit does not provide enough protection against the electrostatic breakdown.

For example, there is a problem that the MOS transistor N itself of the protection circuit electrostatically breaks down when an applied surge voltage is too large to resist.

Furthermore, the above-described conventional MOS transistor type protection circuit uses the breakdown between the source and the drain and the parasitic bipolar operation. Therefore, there is a problem that a surge voltage is applied to the internal circuit before the breakdown occurs between the source and the drain and affects the elements of the internal circuit like causing electrostatic breakdown or the like.

The invention is directed to providing an electrostatic breakdown protection circuit having an enhanced performance of protecting an internal circuit from a surge voltage such as static electricity (resistance to electrostatic breakdown or an operation speed).

### SUMMARY OF THE INVENTION

The invention is directed to solving the above problems and the feature of the invention is as follows. The invention provides an electrostatic breakdown protection circuit connected with a first wiring connecting a terminal and an internal circuit, including: a second wiring supplying a first voltage; first and second capacitors connected between the first wiring and the second wiring and dividing a voltage applied to the first wiring through the terminal; and a MOS transistor of which a drain is connected with the first wiring, a source is connected with the second wiring, and a gate is applied with a voltage divided by the first and second capacitors.

The electrostatic breakdown protection circuit of the invention further includes a first voltage limiting element for limiting a voltage applied to the gate, which is located between the gate and the second wiring.

The electrostatic breakdown protection circuit of the invention further includes a second voltage limiting element for limiting a voltage applied to the gate, which is located between the gate and the first wiring.

### BRIEF DESCRIPTION OF THE DRAWINGS

FIG. 1 is a circuit diagram for explaining an electrostatic breakdown protection circuit of a first embodiment of the invention.

FIG. 2 is a cross-sectional view for explaining a device structure of the electrostatic breakdown protection circuit of the first embodiment of the invention.

FIG. 3 is a circuit diagram for explaining an electrostatic breakdown protection circuit of a second embodiment of the invention.

FIG. 4 is a cross-sectional view for explaining a device structure of the electrostatic breakdown protection circuit of the second embodiment of the invention.

FIG. 5 is a circuit diagram for explaining a conventional electrostatic breakdown protection circuit.

### DETAILED DESCRIPTION OF THE INVENTION

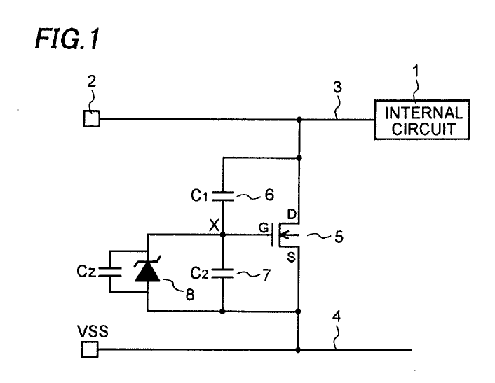

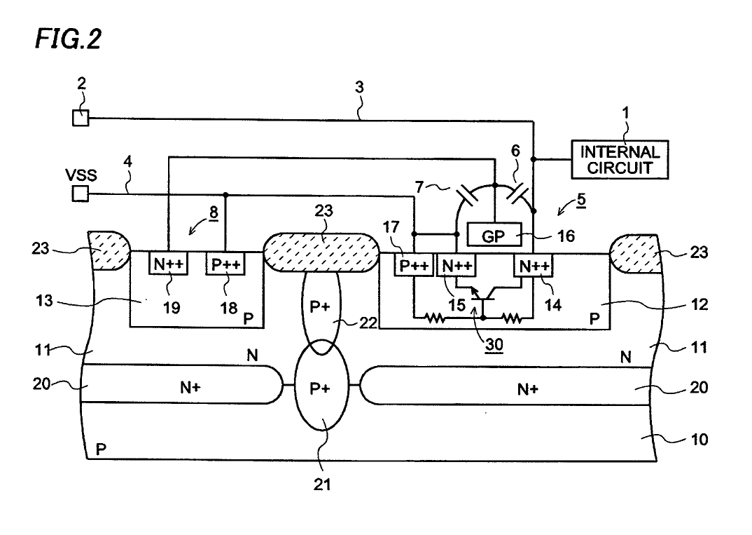

A first embodiment of the invention will be described referring to figures. FIG. 1 is a schematic circuit diagram including an electrostatic breakdown protection circuit of the embodiment, and FIG. 2 is a cross-sectional view of a device structure of this protection circuit.

An internal circuit 1 is provided on a semiconductor substrate made of a silicon wafer or the like. The internal circuit 1 is an analog circuit or a digital circuit, including an input circuit, an output circuit, an input/output circuit or the like. The electrostatic breakdown protection circuit of this embodiment is connected with a wiring 3 (first wiring) connecting the internal circuit 1 and an input terminal or an output terminal (hereafter, referred to as an input/output terminal 2).

The electrostatic breakdown protection circuit of this embodiment includes an N-channel type MOS transistor 5 of which a source is connected with a VSS (usually, ground voltage) wiring 4 (second wiring) and a drain is connected with the wiring 3, a first capacitor 6 connected between a gate of the MOS transistor 5 and the wiring 3 (the drain of the MOS transistor 5), a second capacitor 7 connected between the gate of the MOS transistor 5 and the VSS wiring 4 (the source of the MOS transistor 5), and a Zener diode 8 connected between the gate of the MOS transistor 5 and the VSS wiring 4 (the source of the MOS transistor 5). An anode of the Zener diode 8 is connected with the VSS wiring 4, and a cathode thereof is connected with the gate of the MOS transistor 5.

A node of the gate of the MOS transistor 5, the first capacitor 6, the second capacitor 7 and the Zener diode 8 is a node X and the voltage of this node is Vx. Vx is a divided voltage of a voltage applied to the input/output terminal 2 by capacitances (C1, C2) of the first and second capacitors 6 and 7 and parasitic capacitance (Cz) of the Zener diode 8. The value of this voltage Vx that is to be applied to the gate is arbitrarily selected by adjusting the capacitance values (C1, C2 and Cz) of the first and second capacitors 6 and 7 and the Zener diode 8 respectively. The voltage Vx is set to below 10 V, for example, in order to prevent breakdown of the gate insulation film of the MOS transistor 5 although it depends on the thickness of the gate insulation film.

The capacitance values of the first and second capacitors 6 and 7 and the parasitic capacitance value of the Zener diode 8 are adjusted so as to turn on the MOS transistor 5 by an increase of Vx when a surge voltage is applied to the input/output terminal 2. Furthermore, the capacitance values of the first and second capacitors 6 and 7 and the parasitic capacitance value of the Zener diode 8 are also respectively adjusted so as to forcibly turn on the MOS transistor 5 before breakdown occurs in the MOS transistor 5 and a parasitic bipolar transistor 30 turns on, as described below. Furthermore, the capacitance values of the first and second capacitors 6 and 7 and the parasitic capacitance value of the Zener diode 8 are respectively adjusted so as not to turn on the MOS transistor 5 by the divided voltage Vx in a normal operation where a voltage between a ground voltage and a power supply voltage is applied to the input/output terminal 2.

It is possible to use parasitic capacitance between the gate electrode of the MOS transistor 5 and the source and drain layers thereof as the first and second capacitors 6 and 7. However, it is preferable to add the capacitors for accurately obtaining the divided voltage Vx of a desired value for turning on the MOS transistor 5.

Next, a device structure of the above-described electrostatic breakdown protection circuit of the first embodiment will be described referring to FIG. 2. An N-type epitaxial layer 11 is formed on a P-type semiconductor substrate 10, and P-type well layers 12 and 13 are formed in the front surface of the epitaxial layer 11. The above-described MOS transistor 5 is formed in the well layer 12, and the Zener diode 8 is formed in the well layer 13.

The MOS transistor 5 has a high concentration drain layer 14 and a high concentration source layer 15 formed in the front surface of the well layer 12 and a gate electrode 16 formed on a gate insulation film (not shown). A substrate biasing P⁺⁺ layer 17 is formed in the front surface of the well layer 12 adjacent to this MOS transistor 5.

The Zener diode 8 has a high concentration anode layer 18 and a high concentration cathode layer 19 formed in the front surface of the well layer 13.

A high concentration (N⁺-type) embedded layer 20 is formed in a boundary region between the bottom of the semiconductor substrate 10 and the epitaxial layer 11. The MOS transistor 5 and the Zener diode 8 are electrically isolated by a P-type lower isolation layer 21 and a P-type upper isolation layer 22. The lower isolation layer 21 is formed by diffusing an impurity such as boron upward from the bottom side of the semiconductor substrate 10. The upper isolation layer 22 is formed by diffusing an impurity such as boron downward from the upper surface of the epitaxial layer 11. The upper portion of the lower isolation layer 21 and the lower portion of the upper isolation layer 22 overlap in the epitaxial layer 11, forming a combined isolation layer.

A field insulation film 23 for isolating elements is formed in a region of the front surface of the epitaxial layer 11 except in a region formed with the elements. The field insulation film 23 is formed by a LOCOS (Local Oxidation Of Silicon) method, for example.

When an excess surge voltage is applied to the input/output terminal 2, the NPN-type parasitic bipolar transistor 30 is formed by the drain layer 14, the well layer 12 and the source layer 15 of the MOS transistor 5 respectively serving as a collector layer, a base layer and an emitter layer.

Next, a description will be given on an operation of the thus configured electrostatic breakdown protection circuit of the first embodiment referring to FIGS. 1 and 2.

As described above, in this embodiment, the capacitances (Cl, C2) of the first and second capacitors 6 and 7 and the parasitic capacitance (Cz) of the Zener diode 8 are adjusted so as to forcibly turn on the MOS transistor 5 before breakdown occurs between the source and the drain of the MOS transistor 5 to start the parasitic bipolar operation when the voltage of the input/output terminal 2 exceeds a predetermined voltage. Therefore, when a positive surge voltage is applied to the input/output terminal 2, the divided voltage Vx of a predetermined value is charged almost at the same time and thereby the MOS transistor 5 turns on to flow a current to the VSS wiring 4 side. This operation of the MOS transistor is performed before breakdown occurs in the MOS transistor 5.

Furthermore, when a larger excess positive surge voltage occurs at the input/output terminal 2 and the MOS transistor 5 does not have enough current capability to flow the current, the voltage on the drain side increases, the NPN-type parasitic bipolar transistor 30 also turns on as shown in FIG. 2, and the current flows to the VSS wiring 4 side through both the MOS transistor 5 and the parasitic bipolar transistor 30. This parasitic bipolar operation is a phenomenon where when a breakdown occurs in the junction between the drain layer 14 and the well layer 12 to flow a current into the well layer 12, the voltage of the well layer 12 increases, a base current flows from the well layer 12 to the source layer 15, and thereby the parasitic bipolar transistor 30 turns on.

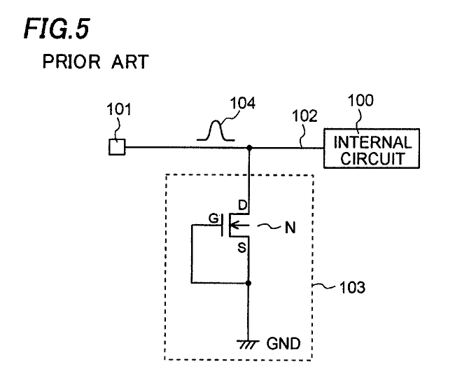

Conventionally (see FIG. 5), a current is flowed by using breakdown between a source and a drain of a MOS transistor and a parasitic bipolar operation. On the other hand, in this embodiment the MOS transistor 5 turns on to let a current escape before the breakdown occurs between the source and the drain and the parasitic bipolar operation starts. This realizes the electrostatic breakdown protection circuit which performs a higher speed operation and has a greater current capability than conventional.

Although the MOS transistor 5 itself breaks down when the voltage Vx applied to the gate of the MOS transistor 5 increases in excess and exceeds the gate breakdown voltage, the voltage Vx is clamped by the Zener diode 8 so as to prevent the voltage between the gate and the source from exceeding a predetermined value in this embodiment. Therefore, the breakdown of the MOS transistor 5 itself is reduced. It is preferable to provide a voltage limiting element in this manner in order to protect the electrostatic breakdown protection circuit element itself (the MOS transistor 5 in this embodiment) from a surge voltage.

When a negative surge voltage is applied to the input/output terminal 2, too, the MOS transistor 5 turns on to protect the internal circuit 1 in the similar manner. In detail, the MOS transistor 5 turns on by the divided voltage Vx to flow a current from the VSS wiring 4 side to the input/output terminal 2 side in this case, thereby protecting the internal circuit 1. Furthermore, a current also flows through the PN junction between the well region 12 and the P⁺⁺ layer 17 and the drain layer 14, thereby protecting the internal circuit 1.

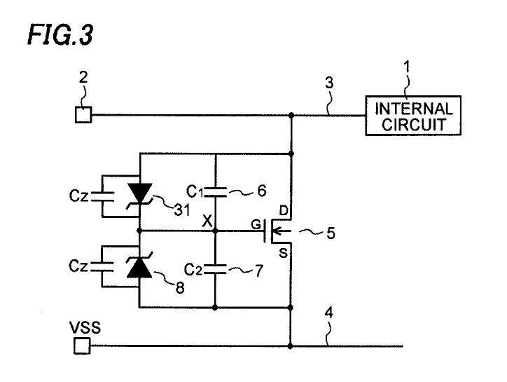

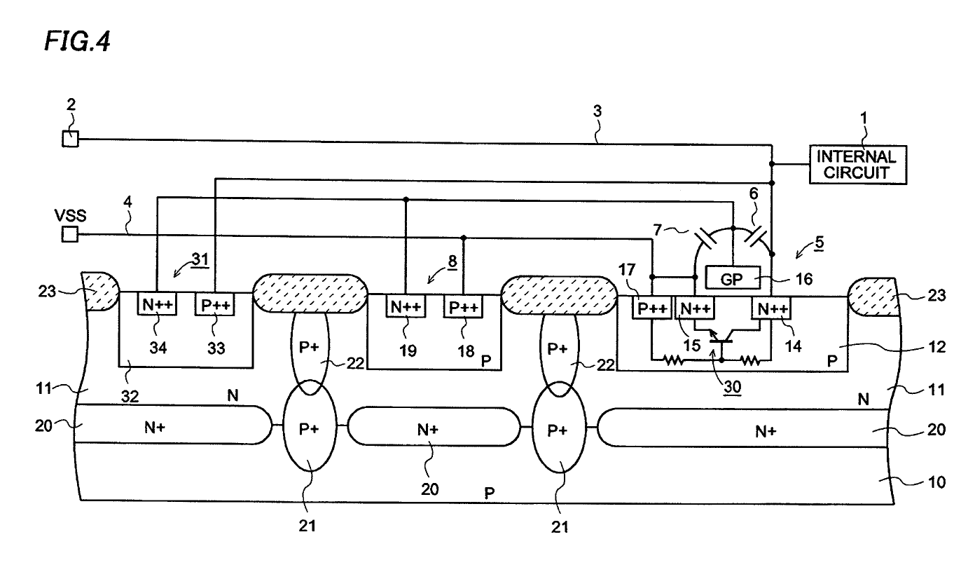

Next, a second embodiment of the invention will be described referring to figures. FIG. 3 is a schematic circuit diagram of an electrostatic breakdown protection circuit of the second embodiment, and FIG. 4 is a cross-sectional view of a device structure of this protection circuit. The same reference numerals are given to the same components as in the first embodiment, and the description thereof will be omitted or simplified.

The electrostatic breakdown protection circuit of the second embodiment includes the N-channel type MOS transistor 5 of which the source is connected with the VSS wiring 4 and the drain is connected with the wiring 3, the first capacitor 6 connected between the gate of the MOS transistor 5 and the wiring 3 (the drain of the MOS transistor 5), the second capacitor 7 connected between the gate of the MOS transistor 5 and the VSS wiring 4 (the source of the MOS transistor 5), the Zener diode 8 connected between the gate of the MOS transistor 5 and the VSS wiring 4 (the source of the MOS transistor 5), and a Zener diode 31 connected between the gate of the MOS transistor 5 and the wiring 3 (the drain of the MOS transistor). An anode of the Zener diode 31 is connected with the wiring 3, and a cathode thereof is connected with the gate of the MOS transistor 5.

Next, the device structure of the electrostatic breakdown protection circuit of this second embodiment will be described referring to FIG. 4. A P-type well layer 32 is formed in the front surface of the N-type epitaxial layer 11, and the Zener diode 31 is formed in the well layer 32. The Zener diode 31 has a high concentration anode layer 33 and a high concentration cathode layer 34 formed in the front surface of the well layer 32. The other structure is the same as in the above-described first embodiment.

The feature of the second embodiment is that the Zener diode 31 is provided between the wiring 3 and the gate of the MOS transistor 5. Taking the parasitic capacitance (Cz) of the Zener diode 31 into account, the capacitance values of the first and second capacitors 6 and 7 and the parasitic capacitance values of the Zener diodes 8 and 31 are respectively adjusted so as to forcibly turn on the MOS transistor 5 before breakdown occurs between the source and the drain of the MOS transistor 5 and the parasitic bipolar operation starts.

The thus configured electrostatic breakdown protection circuit of the second embodiment has a following effect in addition to the effect obtained by the structure of the first embodiment. That is, although the MOS transistor 5 breaks down when an excess voltage is applied to the gate of the MOS transistor 5, the voltage is clamped by the Zener diode 31 so as to avoid applying an excess voltage to the gate in this embodiment. Therefore, in the structure of the second embodiment, it is possible to protect the MOS transistor 5 itself from a negative surge voltage as well as a positive surge voltage.

In this manner, in both the structures of the first and second embodiments described above, the voltage on the input/output terminal side is divided by the capacitors and the divided voltage is applied to the gate of the MOS transistor. Therefore, when an abnormal surge voltage occurs from the input/output terminal, the MOS transistor turns on by the divided voltage to achieve the protection of the internal circuit more immediately than conventional.

Furthermore, since the parasitic bipolar operation is also realized in addition to the MOS transistor operation, the internal circuit is protected by flowing a larger current than conventional.

Furthermore, in the case where the voltage limiting element (the Zener diodes 8 and 31 in this embodiment) for limiting the voltage applied to the gate of the MOS transistor is connected, the protection element itself is prevented from breaking down by a surge voltage.

This invention is not limited to the embodiments described above and may be modified within the scope of the invention. In detail, for example, although the protection circuit is connected with the wiring (the VSS wiring 4) supplying the VSS voltage in the above described embodiments, the protection circuit may be connected with the wiring supplying a high power supply voltage and a P-channel type MOS transistor may be used as the protection circuit element.

The electrostatic breakdown protection circuit of the invention is configured so that the voltage applied to the terminal is divided by the capacitors and the divided voltage is applied to the gate of the MOS transistor. The value of the voltage applied to the gate is arbitrarily selected by adjusting the capacitance values of the first and second capacitors respectively (including the capacitance value of the voltage limiting element when it is provided). This structure allows the MOS transistor to turn on by the divided voltage to flow a current when an abnormal surge voltage occurs, and protects the internal circuit from electrostatic breakdown immediately.

Furthermore, in the case where the voltage limiting element for limiting the voltage applied to the gate of the MOS transistor is connected, the gate of the MOS transistor is prevented from breaking down by a surge voltage and as a result the protection circuit itself is prevented from breaking down.

What is claimed is:

1. An electrostatic breakdown protection circuit connected with a first wiring connecting a terminal and an internal circuit, comprising:
a second wiring supplying a first voltage;
first and second capacitors connected between the first wiring and the second wiring and dividing a voltage applied to the first wiring through the terminal; and
a MOS transistor of which a drain is connected with the first wiring, a source is connected with the second wiring, and a gate is applied with a voltage divided by the first and second capacitors.

2. The electrostatic breakdown protection circuit of claim 1, further comprising a first voltage limiting element for limiting a voltage applied to the gate, which is located between the gate and the second wiring.

3. The electrostatic breakdown protection circuit of claim 1, further comprising a second voltage limiting element for limiting a voltage applied to the gate, which is located between the gate and the first wiring.

4. The electrostatic breakdown protection circuit of claim 2, further comprising a second voltage limiting element for limiting a voltage applied to the gate, which is located between the gate and the first wiring.

5. The electrostatic breakdown protection circuit of claim 2, wherein the voltage limiting element is a Zener diode.

6. The electrostatic breakdown protection circuit of claim 3, wherein the voltage limiting element is a Zener diode.

7. The electrostatic breakdown protection circuit of claim 4, wherein the voltage limiting element is a Zener diode.
